(19) United States
(12) Patent Application Publication
(10) Pub. No.: US 2003/0058107 A1
(43) Pub. Date: Mar. 27, 2003

(54) Personal item locator system

(76) Inventors: Joseph A. Ferrier, Muskegon, MI (US); Edward V. Brandel, Muskegon, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/962,823

(22) Filed: Sep. 25, 2001

(51) Int. Cl. G08B 13/14

(52) U.S. Cl. 340/571; 340/572.1; 340/5.1; 340/5.22; 340/539

(57) ABSTRACT

A personal item unit, for use in a personal item locator system, is attached to a personal item to be located and includes a personal item antenna, a personal item receiver, a personal item controller, a personal item audio output device and a personal item battery contained in a personal item housing. The personal item housing includes a resonating cavity for the personal item audio output device.

### BACKGROUND OF THE INVENTION

The present invention is generally directed to a personal item locator and, more specifically, to a personal item locator system for finding a lost or misplaced item.

Typically, personal item locator systems have included a base unit and one or more remote units that are attached to a personal item that a user may desire to locate in the future, when the personal item is misplaced or lost. A typical remote unit has generally included an output device (e.g., a speaker), a receiver, and control logic, which causes the output device to be activated (e.g., provide an audible noise) when an associated RF signal (code or frequency) is received by the receiver of the remote unit. A typical base unit has included a transmitter and control logic, which monitors a plurality of switches to determine if one or more of the switches has been activated and upon activation of one of the switches provides a corresponding RF signal. As previously mentioned, when a remote unit receives an RF signal, of a proper frequency or code, an associated output device is activated such that a user can find the lost or misplaced article.

As a general rule, commercially available remote units have tended to be large, as compared to many of the items for which they may be attached, and have had a limited operating life due to the fact that remote units have been battery powered. Further, commercially available remote units have been preprogrammed to respond to a particular switch on a base unit, which has required a user to purchase a new preprogrammed remote unit when an existing remote unit has ceased to function. Additionally, commercially available remote units have not generally been designed to operate outside of a base unit area (e.g., a home or office) and have not been designed to work with portable transmitting units.

As such, what is needed is a base unit that is capable of programming a remote unit. Further, what is needed is a remote unit that is small in size relative to an object to which it may be attached. Additionally, it would be desirable for the remote unit to function for an extended period of time (i.e., have an extended battery life). It would also be desirable to provide a portable unit to locate a personal item with an attached remote unit, when the personal item is not located within a base unit area. Finally, it would be desirable to provide a receiver within the portable unit such that the portable unit can be located with a base unit (which may be portable) or another portable unit when the portable unit is lost or misplaced.

### SUMMARY OF THE INVENTION

An embodiment of the present invention is directed to a personal item unit for use in a personal item locator system. The personal item unit is attached to a personal item to be located and includes a personal item antenna, a personal item receiver, a personal item controller, a personal item audio output device, a personal item battery and a personal item housing, which retains the aforementioned components. The personal item antenna is coupled to the personal item receiver and facilitates communication with a base locator unit. The personal item controller is also coupled to the personal item receiver and decodes a received signal and actuates the personal item audio output device when an ID code of a received signal corresponds to a stored ID code of the personal item unit. The personal item battery supplies power to the personal item receiver and the personal item controller. The personal item housing includes a resonating cavity for the personal item audio output device.

According to another embodiment of the present invention, a base locator unit is provided for use in a personal item locator system. The base locator unit includes a base controller, a plurality of personal item switches, a base transmitter, a base antenna and a programming port. The plurality of personal item switches are coupled to the base controller and each correspond to one of a plurality of personal item units that are attached to a personal item to be located. The programming port accepts one of the plurality of personal item units such that the base transmitter can provide a personal item unit programming signal to the accepted one of the plurality of personal item units. The accepted one of the plurality of personal item units stores a unique ID code provided by the base transmitter responsive to the personal item unit programming signal.

According to yet another embodiment of the present invention, a portable locator unit is provided for use in a personal item locator system. The portable locator unit includes a portable controller, a plurality of personal item select switches, a portable transmitter., a portable antenna and a portable receiver. The portable controller is coupled to the plurality of personal item select switches, which each correspond to one of a plurality of personal item units. The portable controller is coupled to the portable transmitter, which transmits one of a plurality of unique identification (ID) codes responsive to the activation of one of the plurality of personal item select switches. The portable antenna is coupled to the portable transmitter and the portable receiver, which is coupled to the portable controller. The portable receiver receives transmissions from a base locator unit and the portable controller responds to a portable locator unit ID code.

These and other features, advantages and objects of the present invention will be further understood and appreciated by those skilled in the art by reference to the following specification, claims, and appended drawings.

### BRIEF DESCRIPTION OF THE DRAWINGS

FIG. 1A is a top view of a base locator unit for use in a personal item locator system, according to an embodiment of the present invention;

FIG. 1B is a side view of the base locator unit of FIG. 1A;

FIG. 2 is a side view of a portable locator unit for use in a personal item locator system that is configured as a pen;

FIG. 3A is top view of a portable locator unit for use in a personal item locator system, configured according to another embodiment of the present invention;

FIG. 3B is an end view of the portable locator unit of FIG. 3A;

FIG. 4A is a top and side view of a personal item unit, according to one embodiment of the present invention;

FIG. 4B is a top and side view of a personal item unit, according to another embodiment of the present invention;

FIG. 5A is a bottom view of the personal item unit of FIG. 4A, with all electronic components removed from the housing;

FIG. 5B is a cross-sectional view of the personal item unit of FIG. 5A, along the line VB-VB;

FIG. 6 is a cross-sectional view of the personal item unit of FIG. 4A, cross-sectioned along the line VI-VI, with some of the electrical components of the unit shown;

FIG. 7 is an electrical schematic of a base locator unit, according to an embodiment of the present invention;

FIG. 8 is an electrical schematic of a portable locator unit, according to an embodiment of the present invention;

FIGS. 9A-9B are electrical schematics of personal item units, according to two different embodiments of the present invention; and

FIG. 10 is a diagram of a personal item locator system including a base locator unit, two portable locator units and three personal item units, according to an embodiment of the present invention.

### DETAILED DESCRIPTION OF PREFERRED EMBODIMENTS

According to the present invention, a personal item locator system allows a personal item, that includes an attached personal item unit, to be located by activation of a switch (e.g., a button switch) located on a base locator unit and/or a portable locator unit. The personal item unit is, preferably, configured as a small disk (e.g., approximately the size of a nickel, but can be larger or smaller depending upon the application) that contains an antenna, a receiver, an output device and a microcontroller. It should be appreciated that a general purpose processor and a memory subsystem or a digital signal processor (DSP) may replace the microcontroller. When the personal item is misplaced and cannot be found, according to the present invention, a user of the system activates an appropriate switch on a base locator unit and/or on a portable locator unit. In response to the switch activation, the locator unit transmits an RF coded signal, i.e., a message, that causes the output device (e.g., a piezoelectric sound element) of an appropriate personal item unit to activate, e.g., emit an audible sound. The message may be provided through a variety of modulation techniques, such as frequency modulation (FM), frequency shift keying (FSK), amplitude shift keying (ASK), on-off keying (OOF), etc. It should be appreciated that the output device may be or include a light source, e.g., a light emitting diode (LED), that flashes responsive to the microcontroller upon receipt of an appropriate RF coded signal.

Preferably, the base locator unit attaches to a base that is semi-permanently mounted to a wall or other convenient location. The portable locator unit may be configured as a pen, a key ring or may take virtually any other configuration, which can easily be attached to a larger personal item, such as a purse or briefcase. The base locator unit is preferably removable from the base such that if a missing item cannot be located within a given area, e.g., a room, the base locator unit can be relocated to another area. Preferably, the portable locator unit includes a built-in receiver such that the portable locator unit can be located by the base locator unit or another portable locator unit, when the portable locator unit is misplaced.

In one embodiment, a base locator unit includes an antenna, six personal item switches, two portable locator unit switches, a program switch and a programming port (e.g., a slot). The programming port receives one of a plurality of personal item units, such that the personal item unit can be programmed (or reprogrammed) with a desired address, which corresponds to one of the personal item switches located on the base locator unit and an address of the base locator unit. Providing programmable personal item units is advantageous in that two or more units may be programmed to the same switch. Further, if a personal item unit is damaged, discarded or obsolete another personal item unit can be programmed to that switch. The personal item unit may be located on or attached to any number of personal items, such as a check book, file, purse, wallet, briefcase, car keys, personal digital assistant (PDA), eyeglasses, toolbox, laptop computer, automobile, portfolio, pet collar, a daytime organizer, a portable CD player, ink pen, remote control, small child in a store and/or anything of value that is capable of being lost or misplaced.

As with prior art devices, the user pushes an appropriate switch on the locator unit (i.e., a base locator unit) and listens for a sound and/or watches for a light to be emitted from the personal item unit, attached to a misplaced personal item. In a preferred embodiment, the personal item units are configured as a disk, although it should be understood that a variety of shapes, such as round, square, rectangular, triangular, oval or octagonal can be implemented, if desired. Preferably, the personal item units are shipped from the manufacturer unprogrammed, but can, alternatively, be preprogrammed if desired. A user of the personal item locator system can then program or reprogram the personal item unit, according to a desired switch of a base locator unit.

In one embodiment a user programs a personal item unit by inserting the personal item unit into a programming port of a base locator unit. The user then actuates the program switch of the base locator unit, followed by a desired one of the personal item switches. A unique address for the personal item unit is then programmed into a memory (located within the microcontroller) of the personal item unit. Upon completion of the programming process, the user removes the personal item unit from the programming port and then attaches, e.g., with adhesive tape, velcro, sunglass strap, magnet, strap, cord, etc., the personal item unit to a personal item that may be lost or misplaced.

In a preferred embodiment, a transmitted message consists of three parts: a mode portion, a base locator unit portion and a personal item unit portion. The first part of the message is the mode portion, which informs a receiver what action is being taken. In one embodiment, a programming mode, a normal operation mode, a program portable locator unit mode, and a shut-down mode are implemented. The programming mode prepares a personal item unit to read and store a base locator unit identification (ID) code and a personal item unit ID code.

In the normal operation mode, a receiver of one or more of the personal item units receives the message, which is read to determine whether the ID codes (i.e., base locator unit and personal item unit) match those of a given personal item unit. The program portable locator unit mode is ignored by the personal item units and when received by an appropriate portable locator unit, causes the portable locator unit to store ID codes (i.e., for the base and portable locator units) for later recognition. The shut-down mode indicates to a personal item unit, whose ID codes (i.e., base locator unit and personal item unit) are contained within the shut-down mode message, that the personal item unit should discontinue providing an alarm and transition to a low-power state. The base locator unit portion of the message contains a unique ID code for the base locator unit. This portion of the message is used to differentiate a base locator unit of one user from a base locator unit of another user and, thus, prevent a base locator unit of one user from causing activation of a personal item unit of another user. It will be appreciated that the number of possible ID codes is determined by the number of bits used for that portion of the message. For example, if eight bits are utilized for the base locator unit ID code, then two-hundred fifty-six different base locator units can be distinguished. Using three bits for the personal item unit ID code of the message allows up to eight personal item units to be addressed or six personal item units and two portable locator units.

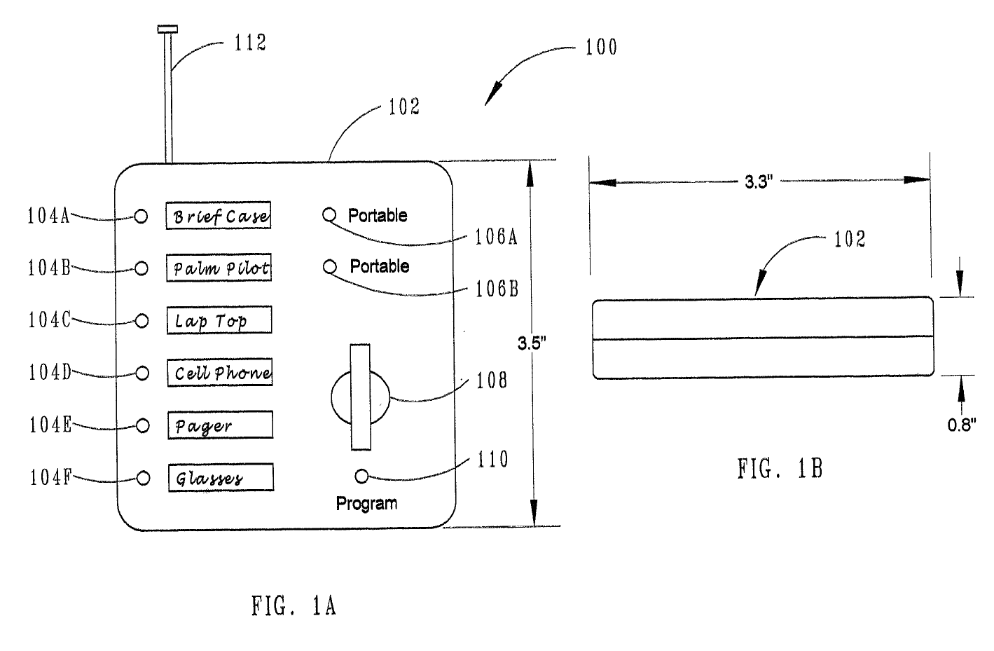

As shown in FIG. 1A, an exemplary base locator unit 100 includes a base antenna 112, a plurality of personal item switches 104A-104F, two portable locator unit switches 106A and 106B and a program switch 110, located in a housing 102. The base locator unit 100 also includes a programming port 108 for accepting one of a plurality of personal item units for programming. The unit 100, shown in FIGS. 1A and 1B, is approximately 3.3 inches in width, 3.5 inches in length and 0.8 inches thick.

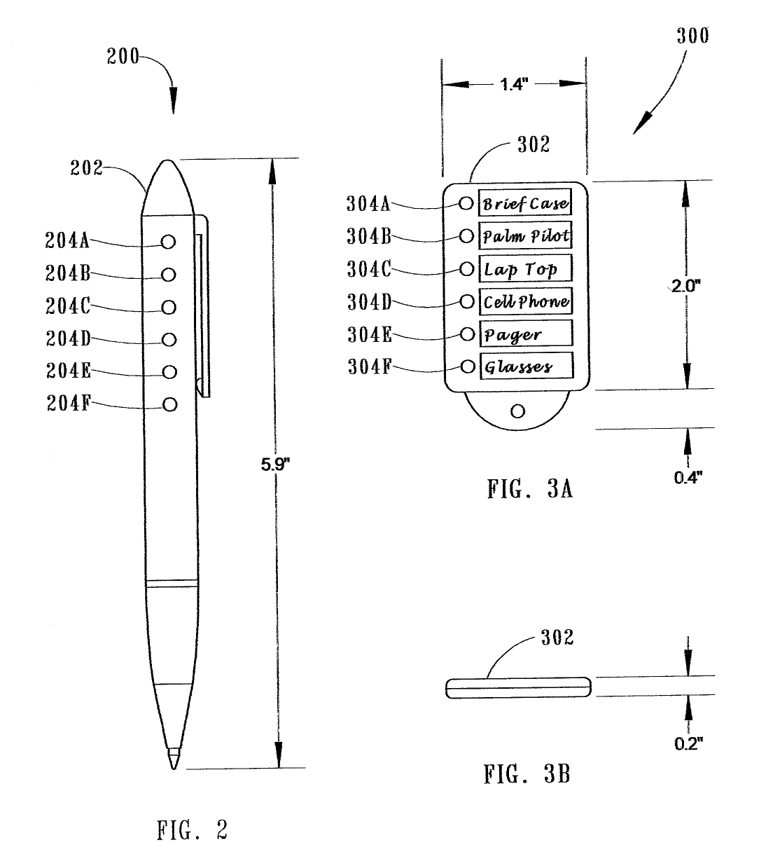

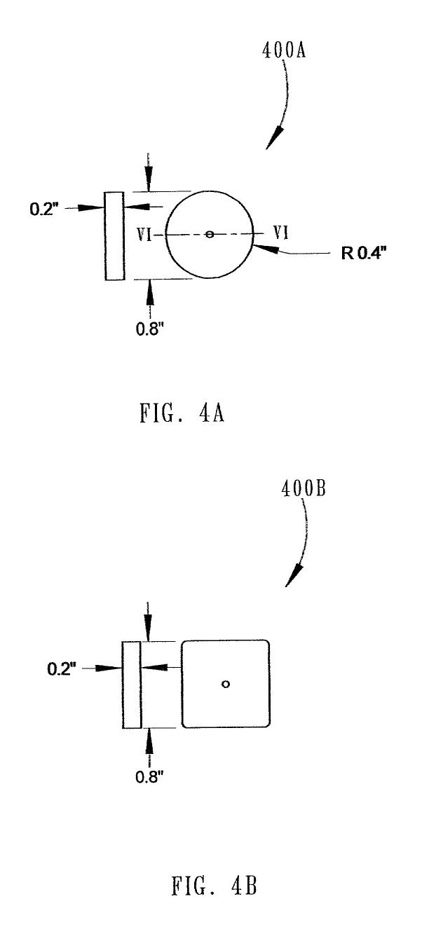

FIG. 2 depicts an exemplary portable locator unit 200, which is configured as a pen, whose housing 202 retains a plurality of personal item switches 204A-204F, which facilitate communication with a corresponding personal item unit. The length of the unit 200, shown in FIG. 2, is approximately 5.9 inches. FIGS. 3A-3B show a top and side view of a universal style portable locator unit 300, according to another embodiment of the present invention. As shown, the unit 300 includes a housing 302 that retains a plurality of personal item switches 304A-304F. The unit 300 is approximately 2 inches long, 1.4 inches wide and 0.2 inches thick. The units 200 and 300 may also include a portable locator unit switch (not shown in FIGS. 2, 3A and 3B) for locating another portable locator unit.

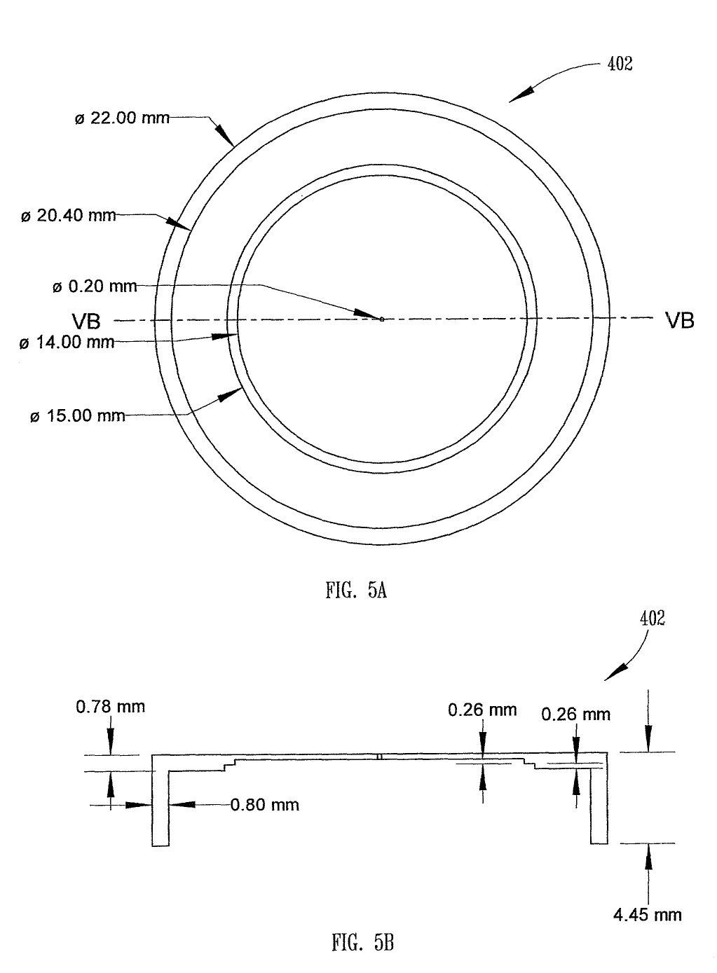

FIG. 4A depicts an exemplary personal item unit 400A, configured as a disk, with an approximate radius of 0.4 inches and a thickness of 0.2 inches (approximately the size of a nickel). FIG. 4B depicts another variation of a personal item unit 400B, when implemented as a square, with an approximate thickness of 0.2 inches and each side being approximately 0.8 inches. It should be appreciated that the disclosed dimensions of the personal item units 400A and 400B of FIGS. 4A-4B are exemplary and are not critical. However, it is desirable to reduce the size of the personal item unit, such that it can be readily utilized with small personal items.

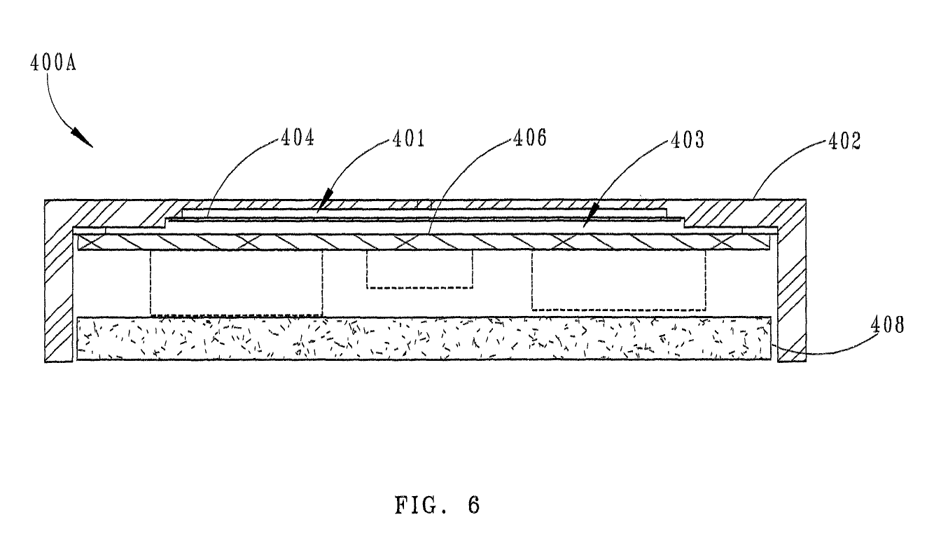

FIG. 5A depicts a bottom view of a housing 402 of the personal item unit 400A of FIG. 4A, according to one embodiment of the present invention, with exemplary dimensions provided and internal components of the unit 400A removed for sake of clarity. FIG. 5B is a cross-sectional view of the housing 402 of FIG. 5A, along the line VB-VB, including approximate dimensions, without any internal components shown. In one embodiment, the substantially disk shaped housing 402 is made of a plastic material and has a diameter of about 0.7 to 0.95 inches and a thickness of about 0.17 inches. In another embodiment, the substantially disk shaped housing 402 has a diameter of about 0.8 inches and a thickness of about 0.17 inches.

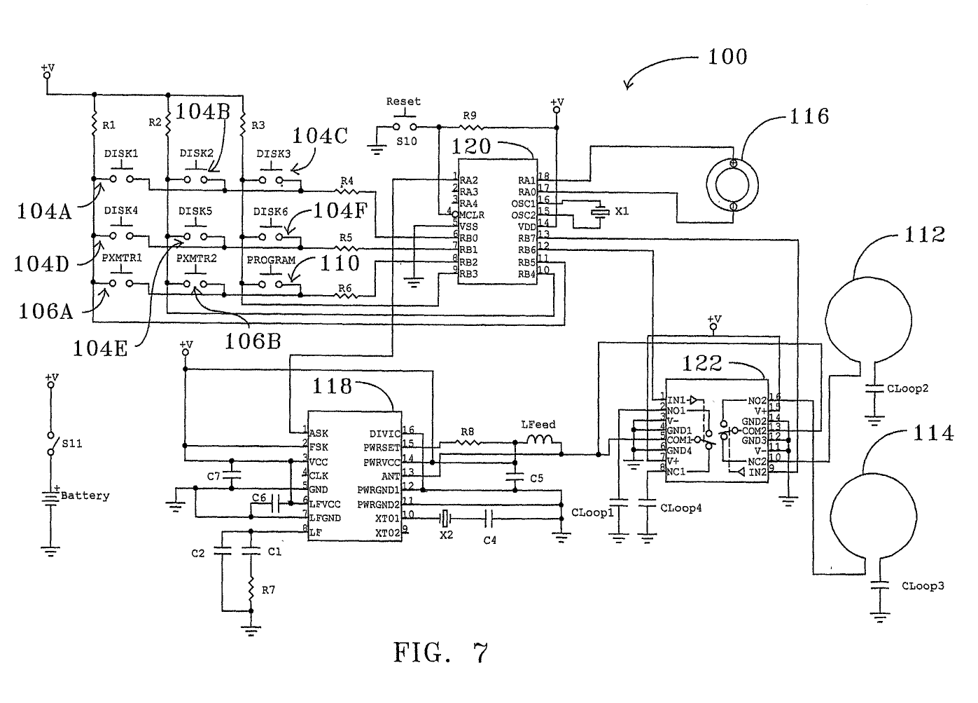

FIG. 6 depicts the personal item unit 400A of FIG. 4A in cross-sectional view, along the line VI-VI, with the internal components of the unit 400A cross-sectioned. The housing 402 provides a cavity 401 and a cavity 403 (i.e., a resonating cavity), which allow piezoelectric element 404 to move in either direction. A printed circuit board (PCB) 406, preferably a thin rigid PCB, connects electrical components (shown in phantom and described further below) of the unit 400A and a battery 408 provides power to the electrical components and preferably provides a rear surface for the unit 400A. Preferably, most of the electrical components (i.e., resistors, capacitors and integrated circuits) are chip components that are soldered directly to a surface of the PCB 406. The battery 408 may be retained in a groove (not shown) formed in an inner surface of the housing 402. Preferably, the integrated circuit chips are soldered directly to a PCB using chip-on-board (COB) or flip-chip technology.

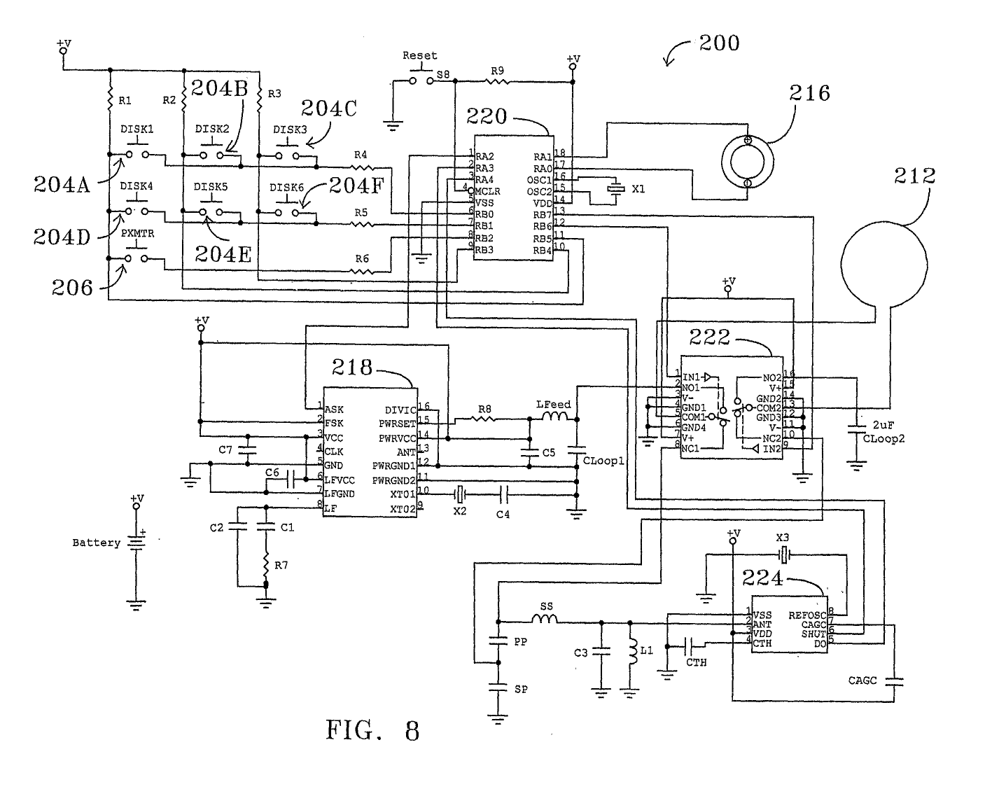

FIG. 7 depicts an electrical schematic of the exemplary base locator unit 100, according to an embodiment of the present invention. In the discussions that follow, with respect to FIGS. 7-9B, electronic components that perform the same function and have the same value use the same designator. As shown in FIG. 7, a plurality of switches 104A-104F, 106A, 106B and 110 are coupled to inputs of a microcontroller 120 (e.g., a PIC16F84 manufactured and made commercially available by Microchip Technologies, Inc.), which monitors the inputs to determine an appropriate course of action. A first side of the switches 104A, 104D and 106A is coupled to a voltage source (e.g., three volts)+V, through a resistor R1 (e.g., 10 kohm), and to an input (RB5) of the microcontroller 120. A second side of the switches 104A, 104B and 104C is coupled to an input (RB0) of the microcontroller 120, through a resistor R4 (e.g., 100 ohm). A second side of the switches 104D, 104E and 104F is coupled to an input (RB1) of the microcontroller 120, through a resistor R5 (e.g., 100 ohm) and a second side of the switches 106A, 106B and 110 is coupled to an input (RB2) of the microcontroller 120, through a resistor R6 (e.g., 100 ohm). A first side of the switches 104B, 104E and 106B is coupled to +V, through a resistor R2 (e.g., 10 kohm), and to an input (RB4) of the microcontroller 120 and a first side of the switches 104C, 104F and 110 is coupled to +V, through a resistor R3 (e.g., 10 kohm), and to an input (RB3) of the microcontroller 120.

By monitoring the inputs from the switches 104A-104F, 106A, 106B and 110, the microcontroller 120 can determine which, if any, of the switches 104A-104F, 106A, 106B and 110 have been actuated and, thus, implement an appropriate routine. For example, the unit 100 may provide a coded RF signal to a personal item unit that is associated with one of the switches 104A-104F and/or a portable locator unit that is associated with one of the switches 106A and 106B. When the switch 110 is actuated, the unit 100 programs an appropriate personal item unit (indicated by which of the switches 104A-104F is actuated after switch 110 is actuated) located within the programming port 108 or an appropriate one of the portable locator units (indicated by which of the switches 106A and 106B is actuated after switch 110 is actuated).

Thus, when the program switch 110 is actuated, the microcontroller 120 determines which of the switches 104A-104F, 106A and 106B is actuated next, and then performs a function appropriate for the next actuated switch. The microcontroller 120 is also coupled to an antenna switch 122 and controls the antenna switch 122 such that either antenna 112 or antenna 114 (i.e., the personal item unit program antenna) is utilized to provide a personal item unit programming signal, a portable locator unit programming signal, a personal item unit location signal or a portable locator unit location signal. Responsive to the microcontroller 120, a base transmitter 118 provides an appropriate signal to the antenna 112 or 114.

The base transmitter 118 is preferably a U2741B manufactured and made commercially available by Atmel. Capacitors C1, C2, C4, C5, C6, C7, inductor LFEED, resistor R8 and crystal X2, whose values are, for example, 15 pF, 3.9 nF, 1 uF, 1 nF, 1 nF, 22 nF, 220 nH, 1 kohm and 13.56 MHz, respectively, are utilized in conjunction with the transmitter 118.

As previously discussed, when a user wishes to program a personal item unit, the user places the personal item unit in the programming port 108 of the base locator unit 100. During the programming operation, the microcontroller 120 is programmed to reduce RF power to a small fraction of normal transmitting power such that only the personal item unit, located in the programming port 108, receives the personal item unit programming signal. According to an embodiment of the present invention, the microcontroller 120 is programmed such that when the programming of the personal item unit is complete, the microcontroller 120 actuates an audio output device (e.g., a piezoelectric element) 116 such that a user is alerted to the end of the programming task. It should be appreciated that the antennas 112 and 114 can be manufactured as part of a PCB or can be made of an individual wire. Antenna 112 can be located inside or outside of the housing 102, depending on the desired transmission distance.

As previously mentioned, the microcontroller 120 interprets the user information provided through the various switches 104A-104F, 106A, 106B and 110, and performs a related task of programming or communicating with a portable locator unit or one of the plurality of personal item units. As shown in FIG. 7, the base locator unit 100 includes two antennas, 112 and 114, one of which is used for normal high power operation (i.e., the antenna 112) at maximum range and the other of which is used for low power (i.e., the antenna 114) and is oriented such that it normally only communicates with the personal item unit that is placed in the programming port 108. A high power RF antenna (i.e., the antenna 112) can be configured as a helix antenna or can be implemented, for example, as a loop antenna with a coil of wire that either occupies the inside perimeter of the case or is molded into the case. The antenna 112 can also be a loop antenna occupying the outside circumference of a PCB or a monopole or dipole of fixed length or telescopic. The PCB antenna can also be configured in a variety of patterns to optimize transmission range of a base locator unit and/or reception range of a portable locator unit.

In a preferred embodiment, the personal item locator system is provided from the manufacturer with the personal item units and the portable locator units unprogrammed. As previously discussed, a user places a personal item unit in the programming port 108 and then actuates the programming switch 110, followed by an appropriate one of the personal item switches 104A-104F to program the personal item unit.

The microcontroller 120 interprets the switches actuated and, after placing the base transmitter 118 in a low-power mode and activating the program antenna 114, outputs a proper coded signal containing the program mode, base locator unit identification (ID) code and the personal item unit ID code to the base transmitter 118. The base transmitter 118 preferably sends the same code several times to ensure proper receipt. A microcontroller of the personal item unit reads and stores the received ID codes associated with the message and then reads another message and compares its ID codes to the stored ID codes for verification. If the ID codes match, the personal item unit preferably provides an audible sound to inform the user that it was programmed successfully. If ID code verification is not successful, then the microcontroller of the personal item unit repeats the read, store and verify sequence until the ID codes of the message are properly stored and verified. Upon completion of the programming of the personal item unit a user attaches it to a personal item, such as a briefcase, laptop or portfolio, and then labels the appropriate switch on the base locator unit 100 and the portable locator unit 200 and/or 300.

When a user misplaces a personal item, the user actuates an appropriate switch 104A-104F to locate the item. The microcontroller 120 interprets the switch actuated and transmits an appropriate message including a mode, base locator unit ID code and personal item unit ID code. Preferably, the message is repeatably transmitted for several seconds or for at least as long as the switch is held. The personal item unit reads the message and when the ID codes match, it emits an audible tone to assist the user in locating the misplaced item. The tone continually sounds for a predetermined period of time, for example, twenty seconds. It should be appreciated that a variety of tones, tunes and/or melodies may be provided since an audible output device of a personal item unit is controlled by the microcontroller 120. If the user locates a misplaced item quickly and wants to shut the alert off, the user can actuate an appropriate one of the switches 104A-104F several times in a short period, e.g., three times in two seconds. The microcontroller 120 reads the switch sequence and compares the time to an internal preset time. When the elapsed time for the switch sequence is within the allotted time, the microcontroller 120 outputs a message, with the shut-down mode and proper ID codes, which is transmitted to the personal item unit. Upon receipt of the shut-down request, an associated personal item unit ceases alerting and powers down into a sleep mode.

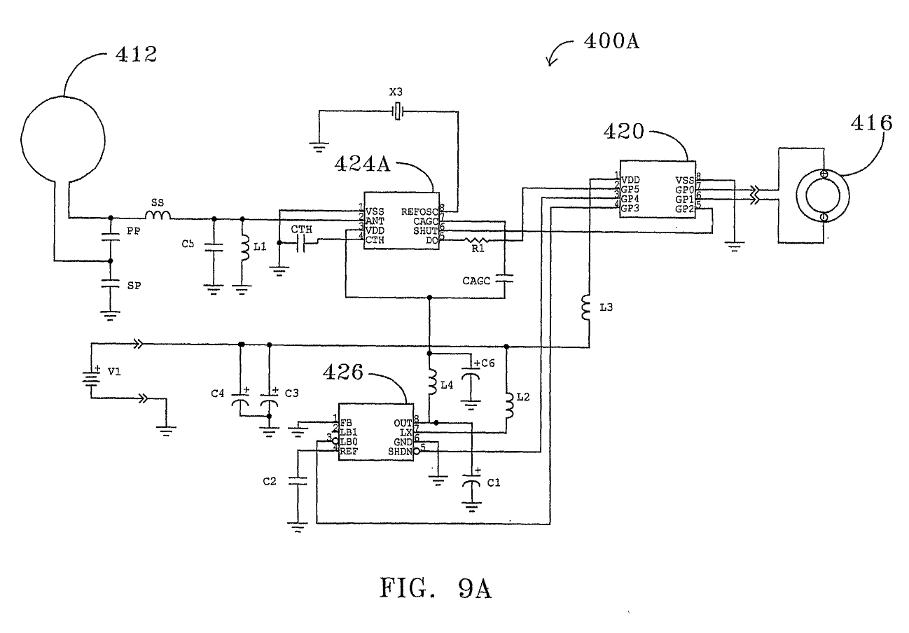

FIG. 8 depicts an electrical schematic of a portable locator unit 200, according to one embodiment of the present invention. A microcontroller 220 is coupled to a plurality of switches 202A-202F and 206, which allows the unit 200 to determine what signal to transmit to, for example, a personal item unit or another portable locator unit. The microcontroller 220 is coupled to and controls an antenna switch 222 for selectively coupling a portable transmitter 218 or a portable receiver 224 to a portable antenna 212. The unit 200 also preferably includes a piezoelectric element 216 coupled to the microcontroller 220, which responsive to an appropriate received signal, activates that piezoelectric element 216 to enable a user of the system to locate the unit 200, when lost or misplaced. A first side of switches 204A, 204D and 206 is coupled to a voltage source +V (e.g., three volts), through a resistor R1 (e.g., 10 kohm), and to an input (RB5) of the microcontroller 220. A first side of switches 204B and 204E is coupled to the voltage source +V, through a resistor R2 (e.g., 10 kohm), and to an input (RB4) of the microcontroller 220. A first side of switches 204C and 204F is coupled to the voltage source +V, through a resistor R3 (e.g., 10 kohm), and to an input (RB3) of the microcontroller 220.

A second side of the switches 204A, 204B and 204C is coupled to an output (RB0) of the microcontroller 220, through a resistor R4 (e.g., 100 ohm). A second side of the switches 204D, 204E and 204F is coupled to an output (RB1) of the microcontroller 220, through a resistor R5 (e.g., 100 ohm). A second side of the switch 206 is coupled to an output (RB2) of the microcontroller 220, through a resistor R6 (e.g., 10 kohm). The microcontroller 220 provides a coded signal to the transmitter 218 and controls the antenna switch 222 such that the transmitter 218 is coupled to the antenna 212, when the microcontroller 220 desires to transmit a signal. In a normal transmission state, the microcontroller 220 couples the antenna 212 to the receiver 224 such that the microcontroller 220 can determine whether a signal is being transmitted from a base locator unit 100 or another portable locator unit to the portable locator unit 200. As previously mentioned, the microcontroller 220 of the portable locator unit 200 may provide an audible output utilizing the piezoelectric element 216 when it receives an appropriate signal from the base locator unit 100 or another portable locator unit.

As previously mentioned, the portable locator unit is preferably configured to be easily and conveniently carried with a user of the system. The portable locator unit allows a user to locate misplaced items, while away from the base locator unit. Advantageously, the portable locator unit may be designed into an object that is normally carried on a user, such as something that is readily available and typically not misplaced. For example, the portable locator unit can be incorporated within an ink pen, a key chain, a wristwatch, etc. Preferably, the universal style portable locator unit 300 (see FIG. 3A) is equipped with a hole for attaching it to a key ring and preferably includes a flat rear surface so that is can be attached to a flat surface with a double sided tape or velcro. The electronic circuitry for the portable locator unit 300 is substantially the same as that of the unit 200 and, as such, is not separately discussed herein.

As previously described, the portable locator unit preferably includes both a transmitter and a receiver. The receiver is provided to allow the user to locate the portable locator unit in the event it is misplaced. Each portable locator unit is preferably capable of locating another portable locator unit such that the missing portable locator unit can be found, when the base locator unit is not readily available. Preferably, the portable locator unit is programmed by the base locator unit by actuating a program switch and then an appropriate portable locator unit switch on the base locator unit. If the user changes the base locator unit configuration, the portable locator unit can be reprogrammed following the same procedures as utilized during initial programming.

Suitable transmitters for the base and portable locator units are widely available from a number of sources, such as Atmel, Micrel, Melexis, Linx and RF Micro Devices. Suitable microcontroller manufacturers include Microchip, Motorola, Zilog and Scenix. It should be appreciated that the transmitter and microcontroller require low operating power, to extend battery life. The transmitter and microcontroller for the portable locator unit should generally also have a small footprint so as to conserve PCB area and the microcontroller should include a sleep mode feature to reduce power consumption, when not in use. The circuits, disclosed herein, have a low profile and require minimum external components, which minimizes cost and PCB complexity and conserves PCB space, which allows the portable housing size to be small and thin, when desired for a given application.

Antennas for the portable locator unit may take a variety of forms, such as loop or helical and may be implemented on a PCB (flexible or rigid) as a trace. When the user is not using the transmitter function, the portable locator unit preferably remains in a receive mode and is periodically checking for correct coded RF signals. When a correct mode, base location unit ID code and personal locator unit ID code is received, the personal locator unit audibly alerts the user. The audible alert can be silenced by, for example, actuating an appropriate switch on the portable locator unit. Preferably, when a portable locator unit is in transmit mode, it transmits for a number of seconds such that a personal item unit that is in sleep mode has an opportunity to come out of sleep mode and check for a received signal. It should be appreciated that the transmitter and receiver of the portable locator unit can be implemented as a transceiver (i.e., a single integrated circuit), if desired.

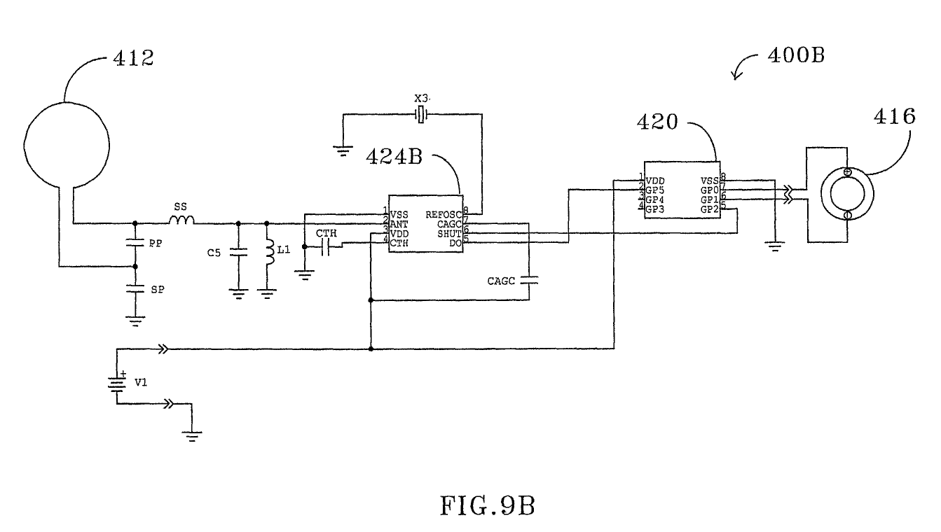

FIGS. 9A-9B depict electrical schematics for personal item units 400A and 400B, according to two slightly different embodiments of the present invention. It should be appreciated that the design and implementation of a personal item unit in a small package is not a simple task. That is, many variables are involved, such as battery interference with antenna performance, which may require alignment of certain components so as to not affect other components adversely. In a preferred embodiment, the personal item unit includes a battery V1 (e.g., three volts) that provides an operational life of at least about nine to twelve months or more, which is achieved by microcontroller 420 controlling various components to put them in a sleep mode and waking them up as appropriate to minimize current consumption.

The primary difference between the embodiments of FIG. 9A and FIG. 9B is that the embodiment of FIG. 9B does not include a DC-to-DC converter (e.g., a MAX1675 manufactured and made commercially available by Maxim Integrated Products, Inc.) 426 and receiver 424A operates on five volts and receiver 424B operates on three volts. As shown in FIG. 9A, the personal unit 400A includes an antenna 412, which is coupled by a matching network of series and/or parallel passive components (e.g., capacitor SP, capacitor PP, inductor SS, capacitor C5 and inductor L1, whose values depend on the operating frequency and antenna parameters) to an input (ANT) of receiver 424A (e.g., a MICRF007 manufactured and made commercially available by Micrel Semiconductor Inc.). It should be appreciated that the values of the components comprising the matching network may require initial tuning depending on the antenna utilized.

As shown, a capacitor CTH is coupled between ground and an input (CTH) of the receiver 424A. A capacitor CAGC is coupled between VDD (five volts) and an input (CAGC) of the receiver 424A. A crystal X3 sets the receiver reference oscillator and is determined by a desired carrier frequency (e.g., in a range of 260 MHz to 928 MHz). An output (DO) of the receiver 424A is coupled to an input (GP5) of the microcontroller 420 (e.g., a PIC12C 509A, manufactured and made commercially available by Microchip Technologies, Inc.), through a current limiting resistor R1 (e.g., 10 kohm). A piezoelectric element 416 is coupled between outputs (GP0 and GP1) of the microcontroller 420, which is programmed to cause the element 416 to emit a sound such that a user of the system can find the personal item unit and, in turn, the misplaced personal item, when an appropriate RF signal is received. The DC/DC converter 426 steps up the level of the voltage source (e.g., from three volts to five volts) provided to power the receiver 424A.

In one embodiment, the microcontroller 420 periodically, for example, every three seconds, checks to determine if a message (i.e., a coded RF signal) has been received. Preferably, the microcontroller 420 wakes up out of a sleep state and then changes the logic state of the DC-to-DC converter 426, which allows the DC-to-DC converter 426 to provide the required voltage to the receiver 424A. The microcontroller 426 then determines if a coded RF signal has been received by the receiver 424A and, if so, receives the coded data at the input (GP5). The received coded data is stored in memory of the microcontroller and checked to determine whether the ID codes correspond to stored ID codes. If the memory of the personal item unit has never been programmed, the microcontroller 420 stores the ID codes in memory for later comparison to received ID codes to determine, for example, whether the piezoelectric element 416 should provide an audible alarm. When the microcontroller 420 determines that the ID codes received match the ID codes stored in memory, the element 416 is activated and the user is alerted as to the location of the missing item. The audible alert continues until a predetermined alert time has elapsed or a shut-down command has been received.

As previously stated, the alert time can be anywhere from a few seconds to minutes. However, a longer alert time requires greater consumption of battery power and, as such, the alert time should be minimized. When the microcontroller 420 receives a receiver shut-down mode signal, the microcontroller 420 initiates shut-down of the unit 400A and discontinues providing an audible alarm. At that time, the microcontroller 420 enters a sleep mode to conserve battery power and extend battery life. The program portable locator unit mode is ignored by the personal item unit 400A as it is intended only for portable locator units.

As previously mentioned, the element 416 is attached between outputs GP0 and GP1 of the microcontroller 420. In this manner, the microcontroller 420 can provide complimentary high/low signals to the element 416, which allows the element 416 to flex mechanically in both directions, thus, improving the sound pressure level, which in turn, increases the audible range. While the element 416 requires activation, the microcontroller 420 periodically, e.g., between audible outputs, looks for a mode bit that tells the microcontroller 420 to shut-down. If the mode bit is not received, the system will preferably sleep until a next audible output is required, to conserve battery power. When a next audible output is required the microcontroller 420 wakes up the DC-to-DC converter 426 (i.e., by providing a wake-up signal on the SHDN input of the converter 426) and the receiver 424A (i.e., by providing a wake-up signal on the SHUT input of the receiver 424A). The microcontroller 420 then checks for data on the data out (DO) pin of the receiver 424A.

When no data is detected, the converter 426 and the receiver 424A are placed in a sleep state until the next resting period of the sounding element 416. If there is data on the data out (DO) pin of the receiver 424A, the microcontroller 420 checks the mode portion of the message to determine if any process is to be accomplished. If the message contains a shut-down mode, then the microcontroller 420 shuts the element 416 off and places all active components and then itself into a sleep state, until the next time it is instructed by software to check for the user summoning the personal item unit.

It is contemplated that a rechargeable battery can be utilized to power a personal item unit. In this embodiment it is contemplated that the rechargeable battery can be recharged by the base locator unit 100 by induction (i.e., the base unit includes a transformer primary and the personal item units include a transformer secondary), when a personal item unit is placed in or near, for example, the programming port 108 of the base locator unit 100. In this embodiment, the unit 100 includes a recharge switch (not shown) that initiates recharging of the rechargeable battery.

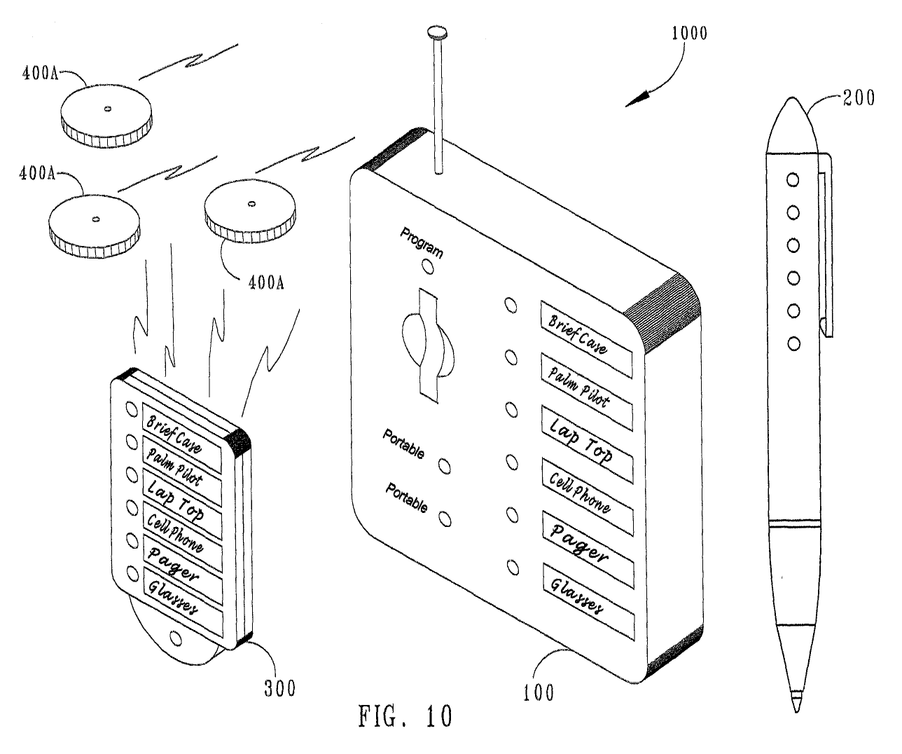

FIG. 10 depicts a personal item locator system 1000 that includes a base locator unit 100, two portable locator units 200 and 300 and three personal item units 400A, according to an embodiment of the present invention. As previously discussed, the portable locator units 200 and 300 can receive coded signals from the base unit 100 and can transmit coded signals to the personal item units 400A. The personal item units 400A receive coded signals from the base locator unit 100 and the portable locator units 200 and 300 and provide an audible output when an appropriate code signal is received. Accordingly, a personal item locator system has been described that allows a personal item, that includes an attached personal item unit, to be located by activation of a switch (e.g., a button switch) located on a base locator unit and/or a portable locator unit.

According to another embodiment, a personal item unit that is attached to a personal item, such as a purse, briefcase, etc., alarms when it fails to receive a coded signal from a portable locator unit (i.e., when the transmission range of the portable locator unit is exceeded) located on a person. In this manner, the alarming personal item unit alerts the person that they have left their personal item behind.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. A base locator unit for use in a personal item locator system, the base locator unit comprising:
a base controller;
a plurality of personal item switches coupled to the base controller, wherein each of the personal item switches correspond to one of a plurality of personal item units that each include a personal item receiver and are attached to a personal item to be located;
a base transmitter coupled to the base controller, the base transmitter transmitting a personal item unit location signal that includes one of a plurality of unique identification (ID) codes responsive to the activation of each of the plurality of personal item switches, wherein one of the plurality of personal item units responds when a corresponding one of the plurality of unique ID codes is received;
a base antenna coupled to the base transmitter; and
a programming port for accepting one of the plurality of personal item units, wherein the base transmitter is configured to provide a personal item unit programming signal to the accepted one of the plurality of personal item units, and wherein the accepted one of the plurality of personal item units stores a unique ID code provided by the base transmitter responsive to the personal item unit programming signal.

2. The base locator unit of claim 1, further including:
a program switch coupled to the base controller;
a program antenna coupled to the base transmitter, wherein the program antenna is located adjacent the programming port to facilitate communication between the base transmitter and the accepted one of the plurality of personal item units; and
an antenna switch coupled between the base transmitter and the base and program antennas, wherein the antenna switch is coupled to the base controller and the base controller monitors the program switch and provides an antenna control signal to the antenna switch responsive to the program switch to cause the antenna switch to selectively couple the base transmitter to one of the base antenna and the program antenna.

3. The base locator unit of claim 2, wherein the base and program antennas are one of a helical antenna and a loop antenna.

4. The base locator unit of claim 1, wherein the personal item unit programming signal is substantially lower in power than the personal item unit location signal.

5. The base locator unit of claim 1, wherein one of the plurality of personal item units responds to one of the plurality of unique ID codes when appropriate by providing an audible sound.

6. The base locator unit of claim 1, further including:
a first portable locator unit switch coupled to the base controller, wherein the first portable locator unit switch corresponds to a first portable locator unit that includes a portable receiver, and wherein the base transmitter transmits a message that includes a unique first portable locator unit identification (ID) code responsive to the activation of the first portable locator unit switch, and wherein the first portable locator unit responds to the unique first portable locator unit ID code when received.

7. A personal item unit for use in a personal item locator system, the personal item unit being attached to a personal item to be located, the personal item unit comprising:
a personal item antenna for facilitating communication with at least one of a base locator unit and a portable locator unit;
a personal item receiver coupled to the personal item antenna;
a personal item controller coupled to the personal item receiver;
a personal item audio output device coupled to the personal item controller, the personal item controller decoding a received signal and actuating the personal item audio output device when an ID code of the received signal corresponds to a stored ID code of the personal item unit;
a personal item battery for supplying power to the personal item receiver and the personal item controller; and
a personal item housing for retaining the personal item antenna, the personal item controller, the personal item audio output device and the personal item battery, wherein the personal item housing includes a resonating cavity for the personal item audio output device.

8. The personal item unit of claim 7, wherein the resonating cavity is integrally formed in the personal item housing and allows the personal item audio output device to flex in opposite directions.

9. The personal item unit of claim 7, wherein the personal item housing is made of a plastic material and is substantially disk shaped with a diameter of about 0.7 to 0.95 inches and a thickness of about 0.17 inches.

10. The personal item unit of claim 7, wherein the personal item battery provides a rear surface for the personal item unit.

11. The personal item unit of claim 7, wherein the personal item audio output device is a piezoelectric element.

12. The personal item unit of claim 7, wherein the personal item battery provides sufficient operating power to the personal item unit for at least about nine to twelve months.

13. A portable locator unit for use in a personal item locator system, the portable locator unit comprising:
a portable controller;
a plurality of personal item select switches coupled to the portable controller, wherein each of the personal item select switches correspond to one of a plurality of personal item units that each include a personal item receiver;
a portable transmitter coupled to the portable controller, the portable transmitter transmitting one of a plurality of unique identification (ID) codes responsive to the activation of each of the plurality of personal item select switches, wherein one of the plurality of personal item units responds to one of the plurality of unique ID codes when appropriate;
a portable antenna coupled to the portable transmitter; and
a portable receiver coupled to the portable controller, the portable receiver receiving transmissions from a base transmitter, wherein the portable controller responds to a portable locator unit ID code.

14. The portable locator unit of claim 13, further including:
a portable audio output device that is activated by the portable controller responsive to receipt of the portable locator unit ID code.

15. The portable locator unit of claim 13, wherein the portable transmitter and the portable receiver are integrated within a single integrated circuit.

16. The portable locator unit of claim 13, further including:
a portable locator unit switch coupled to the portable controller, wherein the portable transmitter transmits a unique portable locator unit identification (ID) code responsive to the activation of the portable locator unit switch, and wherein a second portable locator unit responds to the second portable locator unit ID code when received.

17. A personal item locator system, comprising:
a plurality of personal item units for attaching to personal items to be located, the plurality of personal item units each including:
a personal item antenna for facilitating communication with a base locator unit;
a personal item receiver coupled to the personal item antenna;
a personal item controller coupled to the personal item receiver;
a personal item output device coupled to the personal item controller, the personal item controller decoding a received signal and actuating the personal item output device when an identification (ID) code in the received signal corresponds to a stored ID code of the personal item unit;
a personal item battery for supplying power to the personal item receiver and the personal item controller; and
a personal item housing for retaining the personal item antenna, the personal item controller, the personal item output device and the personal item battery, wherein the housing has a diameter of about 0.80 inches and a thickness of about 0.17 inches; and
a base locator unit, including:
a base controller;
a plurality of personal item switches coupled to the base controller, wherein each of the plurality of personal item switches correspond to one of the plurality of personal item units;
a base transmitter coupled to the base controller, the base transmitter transmitting a personal item unit location signal that includes one of a plurality of unique identification (ID) codes responsive to the activation of each of the plurality of personal item switches, wherein one of the plurality of personal item units responds when a corresponding one of the plurality of unique ID codes is received; and
a base antenna coupled to the base transmitter.

18. The system of claim 17, wherein the base locator unit further includes:
a programming port for accepting one of the plurality of personal item units, the base transmitter providing a personal item unit programming signal to the accepted one of the plurality of personal item units, wherein the personal item unit programming signal includes the stored ID code, and wherein the accepted one of the plurality of personal item units stores the stored ID code in response to receipt of the personal item unit programming signal.

19. The system of claim 17, wherein the personal item housing is made of a plastic material and is substantially disk shaped and the personal item battery provides sufficient operating power to the personal item unit for at least about nine to twelve months and provides a rear surface for the personal item unit, and wherein the personal item output device is a piezoelectric element.

20. The system of claim 18, the base locator unit further including:
a program switch coupled to the base controller;
a program antenna coupled to the base transmitter, wherein the program antenna is located adjacent the programming port to facilitate communication between the base transmitter and the accepted one of the plurality of personal item units; and
an antenna switch coupled between the base transmitter and the base and program antennas, wherein the antenna switch is coupled to the base controller and the base controller monitors the program switch and provides an antenna control signal to the antenna switch responsive to the program switch to cause the antenna switch to selectively couple the base transmitter to one of the base antenna and the program antenna.

21. The system of claim 17, the base locator unit further including:
a portable locator unit switch coupled to the base controller, wherein the portable locator unit switch corresponds to a portable locator unit that includes a portable locator receiver, and wherein the base transmitter transmits a message that includes a unique portable locator unit identification (ID) code responsive to the activation of the portable locator unit switch, and wherein the portable locator unit responds to the unique portable locator unit ID code when received.

22. A base locator unit for use in a personal item locator system, the base locator unit comprising:
a base controller;
a plurality of personal item switches coupled to the base controller, wherein each of the personal item switches correspond to at least one of a plurality of personal item units that each include a personal item receiver and are attached to a personal item to be located;
a programming switch coupled to the base controller;
a base antenna coupled to the base transmitter; and
a base transmitter coupled to the base controller, the base transmitter transmitting a personal item unit programming signal responsive to the activation of the programming switch, wherein one of the plurality of personal item units receives the personal item unit programming signal and stores a unique identification (ID) code provided by the base transmitter responsive to the personal item unit programming signal.

23. The base locator unit of claim 22, further including:
a programming port for accepting one of the plurality of personal item units such that the personal item unit programming signal is only received by the accepted one of the plurality of personal item units.

24. The base locator unit of claim 23, further including:
a program antenna coupled to the base transmitter, wherein the program antenna is located adjacent the programming port to facilitate communication between the base transmitter and the accepted one of the plurality of personal item units; and
an antenna switch coupled between the base transmitter and the base and program antennas, wherein the antenna switch is coupled to the base controller and the base controller monitors the program switch and provides an antenna control signal to the antenna switch responsive to the program switch to cause the antenna to selectively couple the base transmitter to one of the base antenna and the program antenna.

25. The base locator unit of claim 22, wherein the unique ID code includes a base locator unit ID code and a personal item unit ID code.

26. A personal item unit for use in a personal item locator system, the personal item unit being attached to a personal item to be located, the personal item unit comprising:
a personal item antenna for facilitating communication with at least one of a base locator unit and a portable locator unit;
a personal item receiver coupled to the personal item antenna;
a personal item controller coupled to the personal item receiver;
a personal item audio output device coupled to the personal item controller, the personal item controller decoding a received signal and actuating the personal item audio output device when an ID code of the received signal corresponds to a stored ID code of the personal item unit;
a personal item battery for supplying power to the personal item receiver and the personal item controller; and
a personal item housing for retaining the personal item antenna, the personal item controller, the personal item audio output device and the personal item battery.

27. The personal item unit of claim 26, wherein the personal item housing includes a resonating cavity that allows the personal item audio output device to flex in opposite directions.
